(19) United States
(12) Patent Application Publication
(10) Pub. No.: US 2019/0114232 A1
(43) Pub. Date: Apr. 18, 2019

(54) LOCAL AND OFFLOADED SNAPSHOTS FOR VOLATILE MEMORY

(71) Applicant: Christopher Squires, Boulder, CO (US)

(72) Inventor: Christopher Squires, Boulder, CO (US)

(21) Appl. No.: 15/786,206

(22) Filed: Oct. 17, 2017

(51) Int. Cl. G06F 11/14; G06F 11/07; G06F 15/173

(52) U.S. Cl. CPC G06F 11/1464; G06F 11/0793; G06F 13/28; G06F 11/0748; G06F 15/17331

(57) ABSTRACT

Embodiments describe snapshot generation and retrieval for volatile memory utilizing remote storage targets. One embodiment comprises an apparatus that includes a volatile memory, a Central Processing Unit (CPU), a network interface, a non-volatile memory, and a controller. The CPU is communicatively coupled to the volatile memory, and accesses contents of the volatile memory. The network interface communicates with a storage target over a network. The controller is communicatively coupled to the volatile memory, the network interface, and the non-volatile memory. The controller, responsive to a trigger, generates a snapshot comprising contents of the volatile memory, and stores the snapshot in the non-volatile memory. The controller transmits the snapshot to the storage target utilizing the network interface.

### FIELD

This disclosure relates to the field of storage systems, and in particular, to the use of local and remote snapshot storage for volatile memory.

### BACKGROUND

In computer systems, a snapshot is the state of a computing system at a particular point in time. Snapshots typically store the state of a computing system to allow this saved state to be restored at a later time. However, in some cases it may be desirable to provide finer control over how snapshots are generated and restored. For example, it may be desirable to snapshot a particular memory module or portion of a memory module in a host system, and have some flexibility in how the snapshots are restored for use by the host system.

### SUMMARY

Embodiments describe snapshot generation and retrieval for volatile memory utilizing remote storage targets.

One embodiment comprises an apparatus that includes a volatile memory, a Central Processing Unit (CPU), a network interface, a non-volatile memory, and a controller. The CPU is communicatively coupled to the volatile memory, and accesses contents of the volatile memory. The network interface communicates with a storage target over a network. The controller is communicatively coupled to the volatile memory, the network interface, and the non-volatile memory. The controller, responsive to a trigger, generates a snapshot comprising contents of the volatile memory, and stores the snapshot in the non-volatile memory. The controller transmits the snapshot to the storage target utilizing the network interface.

Another embodiment comprises a method operable by an apparatus that includes a volatile memory, a CPU communicatively coupled to the volatile memory that accesses contents of the volatile memory, a network interface communicatively coupled to a storage target over a network, a non-volatile memory, and a controller communicatively coupled to the volatile memory, the network interface, and the non-volatile memory. The method comprises generating, by the controller in response to a trigger, a snapshot comprising contents of the volatile memory. The method further comprises storing, by the controller, the snapshot in the non-volatile memory, and transmitting, by the controller, the snapshot to the storage target utilizing the network interface.

Another embodiment comprises an apparatus that includes a volatile memory, a CPU, a network interface, a non-volatile memory, and a controller. The CPU is communicatively coupled to the volatile memory, and accesses contents of the volatile memory. The network interface communicates with a storage target over a network. The controller is communicatively coupled to the volatile memory, the network interface, and the non-volatile memory. The controller, responsive to a trigger, retrieves a snapshot from the storage target, and stores the snapshot in the non-volatile memory. The controller restores contents of the volatile memory using the snapshot.

Another embodiment comprises a method operable by an apparatus that includes a volatile memory, a CPU communicatively coupled to the volatile memory that accesses contents of the volatile memory, a network interface communicatively coupled to a storage target over a network, a non-volatile memory, and a controller communicatively coupled to the volatile memory, the network interface, and the non-volatile memory. The method comprises retrieving, by the controller in response to a trigger, a snapshot from the storage target. The method further comprises storing, by the controller, the snapshot in the non-volatile memory, and restoring, by the controller, contents of the volatile memory using the snapshot.

The above summary provides a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments are now described, by way of example only, and with reference to the accompanying drawings. The same reference number represents the same element or the same type of element on all drawings.

FIG. 1 illustrates a system that includes a storage target that stores snapshots for a host system in an exemplary embodiment.

FIG. 2 is a flow chart of a method operable by the controller of the host system illustrated in FIG. 1 for generating snapshots in an exemplary embodiment.

FIGS. 3-6 illustrate additional physical configurations for the controller of FIG. 1 in exemplary embodiments.

FIG. 7 is a flow chart of another method operable by the controller of the host system illustrated in FIG. 1 for restoring snapshots in an exemplary embodiment.

### DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

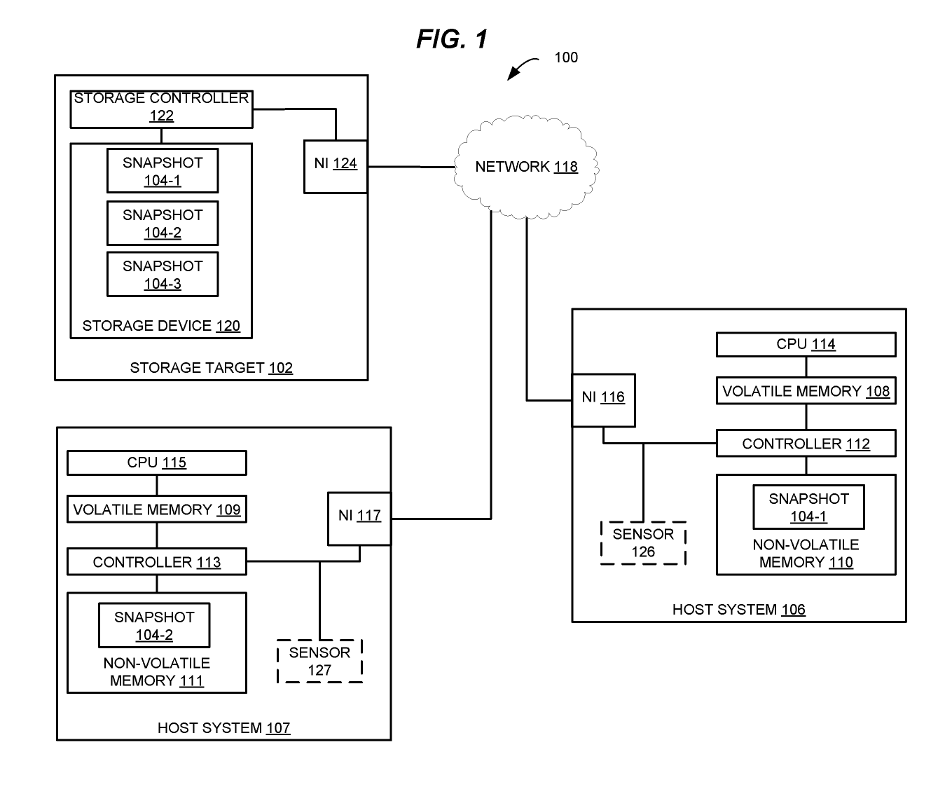

FIG. 1 illustrates a system 100 that includes a storage target 102 that stores snapshots 104 for host systems 106-107 in an exemplary embodiment. Although only one storage target and two host systems are illustrated in FIG. 1, system 100 may include any number of storage targets and/or host systems.

In this embodiment, snapshots 104 comprise the complete contents or the partial contents of volatile memories 108-109 at host systems 106-107. For example, snapshots 104 may be generated to capture the information stored by volatile memories 108-109 at a particular instant in time. Thus, the use of snapshots 104 allows for recovering the particular state of the contents of volatile memories 108-109 stored previously, at some later time. In this specific embodiment, storage target 102 stores snapshot 104-1, snapshot 104-2, and snapshot 104-3, each representing the contents of volatile memories 108-109 at a different point in time. Also illustrated in FIG. 1 is snapshot 104-1 stored by a non-volatile memory 110, which comprises the contents of volatile memory 108, and snapshot 104-2 stored by non-volatile memory 111, which comprises the contents of volatile memory 109. Since snapshots 104 may be large, it is desirable to transfer or offload this data to storage target 102 to make room for subsequent snapshots and/or for data protection. For instance, non-volatile memories 110-111 may be limited in storage such that only one snapshot may be stored at a time. Although only one volatile memory 108 is illustrated for host system 106, host system 106 may include any number of volatile memory devices as a matter of design choice. For instance, volatile memory 108 may comprise one or more Dual In-line Memory Modules (DIMMs), one or more memory devices on a DIMM, etc. In like manner, volatile memory 109 of host system 107 may comprise one or more DIMMs, one or more memory devices on a DIMM, etc.

In this embodiment, host system 106 includes a controller 112, which is capable of generating snapshots 104 of volatile memory 108, and is also capable of restoring snapshots 104 to volatile memory 108. Thus, controller 112 includes any component, system, or device that is able to generate and restore snapshots 104 to volatile memory 108. Controller 112 may include one or more hardware processors, Central Processing Units (CPU's), dedicated hardware memory devices, etc. Host system 107 includes a controller 113, which is capable of generating snapshots 104 of volatile memory 109, and is also capable of restoring snapshots 104 to volatile memory 109. Thus, controller 113 includes any component, system, or device that is able to generate and restore snapshots 104 to volatile memory 109. Controller 113 may include one or more hardware processors, Central Processing Units (CPU's), dedicated hardware memory devices, etc. Additional controllers, not shown, may be associated with additional volatile memories (not shown)

While the specific hardware implementation of host systems 106-107 is subject to design choices, one particular embodiment for host system 106 may include one or more CPUs 114 communicatively coupled with volatile memory 108. In like manner, one particular embodiment for host system 107 may include one or more CPUs 115 communicatively coupled with volatile memory 109. CPUs 114-115 may include any electronic circuits and/or optical circuits that are able to perform functions. For example, CPU 114 may execute instructions stored by volatile memory 108, which may in turn modify data stored by volatile memory 108. In like manner, CPU 115 may execute instructions stored by volatile memory 109, which may in turn modify data stored by volatile memory 109. Some examples of CPUs 114-115 include INTEL® CORE™ processors, Advanced Reduced Instruction Set Computing (RISC) Machines (ARM®) processors, etc.

Volatile memory 108 of host system 106 includes any electronic circuits, and/or optical circuits that are able to store data and/or instructions for CPU 114. In like manner, volatile memory 109 of host system 107 includes any electronic circuits, and/or optical circuits that are able to store data and/or instructions for CPU 115. Volatile memories 108-109 may include one or more volatile Dynamic Random-Access Memory (DRAM) devices, volatile Static RAM devices, etc. Generally, volatile memories 108-109 lose their data when power is lost.

Non-volatile memory 110 of host system 106 and non-volatile memory 111 of host system 107 may include any electronic circuits, and/or optical circuits, and/or magnetic circuits that are able to store data. Non-volatile memories 110-111 and volatile memories 108-109 may include one or more non-volatile Dynamic Random-Access Memory (DRAM) devices, FLASH devices, non-volatile Static RAM devices, magnetic disk drives, Solid State Disks (SSDs), etc. Some examples of non-volatile DRAM and SRAM include battery-backed DRAM and battery-backed SRAM.

Host system 106 in this embodiment further includes a network interface (NI) 116, which allows host system 106 to communicate with storage target 102 via network 118. Host system 107 in this embodiment also includes a network interface (NI) 117, which allows host system 107 to communicate with storage target 102 via network 118. Network interfaces 116-117 may include hardware, software, or combinations of hardware and software that are able to provide communication capabilities between host systems 106-107 and network 118. Some examples of network 118 includes Ethernet networks, 802.11 wireless networks, Fiber Channel networks, InfiniBand networks, etc. In this embodiment, storage target 102 also includes a network interface (NI) 124, which may have similar capabilities as network interfaces 116-117 of host systems 106-107. Additional network interfaces (not shown) may be associated with additional volatile memories (not shown). Further, different host systems may utilize the same or different networks.

In this embodiment, storage target 102 includes at least one storage device 120, which persistently stores snapshots 104 for host systems 106-107. Storage device 120 includes one or more non-volatile Dynamic Random-Access Memory (DRAM) devices, FLASH devices, non-volatile Static RAM devices, magnetic disk drives, Solid State Disks (SSDs), etc. Some examples of non-volatile DRAM and SRAM include battery-backed DRAM and battery-backed SRAM. A storage controller 122 of storage target 102 may coordinate the activities performed by storage target 102 to store snapshots 104 for host systems 106-107, and to retrieve snapshots 104 for host systems 106-107. Further, snapshots 104 may be stored entirely at storage target 102 and/or may be stored on multiple storage targets. Storing snapshots 104 on multiple storage targets may ensure erasure encoding, provide for the use of Redundant Array of Independent Disks (RAID) storage algorithms, or other methodologies.

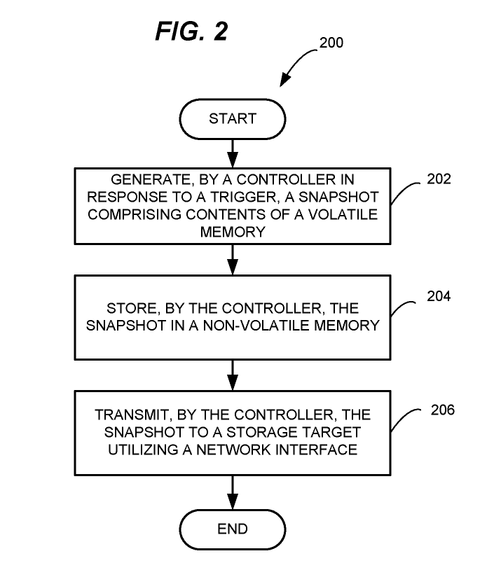

Consider that system 100 is operational and that controller 112 and/or controller 113 is ready to generate snapshots of volatile memory, and is also ready to restore snapshots to volatile memory. FIG. 2 is a flow chart of a method 200 operable by controller 112 of host system 106 and/or controller 113 of host system 107 for generating snapshots in an exemplary embodiment. The methods described herein will be discussed with respect to host system 106 of FIG. 1, although the methods may be performed by other systems (e.g., host system 107), not shown. The methods may include other steps, not shown. Also, the steps may be performed in an alternate order.

Controller 112 generates a snapshot (e.g., snapshot 104-1) of the contents of volatile memory 108 in response to a trigger, and stores snapshot 104-1 in non-volatile memory 110 (see steps 202 and 204, respectively). For example, the trigger to generate a snapshot may be a remote request received from network 118 by network interface 116 (e.g., by any third-party entity), or the trigger to generate a snapshot may be generated via a direct electrical connection to controller 112. In some embodiments, the trigger to generate a snapshot is initiated by controller 112 in response to detecting a failure in the electrical power supplied to host system 106. For instance, controller 112 may utilize an optional sensor 126 to monitor the electrical power supplied to host system 106, and initiate the trigger to generate a snapshot in response to determining that electrical power supplied to host system 106 has been interrupted. In some embodiments, step 204 may be skipped.

In response to storing snapshot 104-1 in non-volatile memory 110, controller 112 transmits snapshot 104-1 to storage target 102 utilizing network interface 116 (see step 206). Step 206 may occur immediately following step 204, or at a later time. To transmit snapshot 104-1, controller 112 may transmit snapshot 104-1 to storage target 102 utilizing Remote Direct Memory Access (RDMA), which allows for direct memory access transfer from host system 106 to storage target 102. RDMA is a direct memory transfer architecture, which allows computers to directly transfer data from the host memory of one computer to the host memory of another computer with minimal or no interaction of the operating systems at either host.

In cases where storage target 102 utilizes an object-based storage system, controller 112 may transmit snapshot 104-1 to storage target 102 utilizing Object-based Storage Device (OSD) commands. An OSD manages objects at the storage device level. An OSD organizes data as variable sized objects, rather than as fixed sized blocks. Each object includes data as a sequence of bytes and may include metadata which describes the object. OSD interfaces at the client level includes commands to create and delete objects, write bytes and read bytes to and from individual objects, and may have the ability to set and get attributes (e.g., access the metadata) on objects. Since objects are managed with a Global Unique Identifier (GUID), the OSD interacts with a host system using the GUID rather than at the block level. This abstraction allows the host system to be ambivalent regarding where or how an object is actually stored by an OSD.

When a host system is tasked with storing an object at an OSD, the host system provides the OSD with the object and a GUID. The OSD stores the object at persistent storage and internally references the data for the object with the GUID. When the host system is tasked with retrieving the object, the host system provides the GUID to the OSD. The OSD uses the GUID to identify where the object is stored at persistent storage, retrieves the object from the persistent storage, and provides the object to the host system (e.g., over a network). The host system then places the object in local memory to allow applications executing on the host system to interact with the object.

In cases where storage target 102 utilizes a file storage system, storage target 102 stores snapshots 104 in a hierarchical structure.

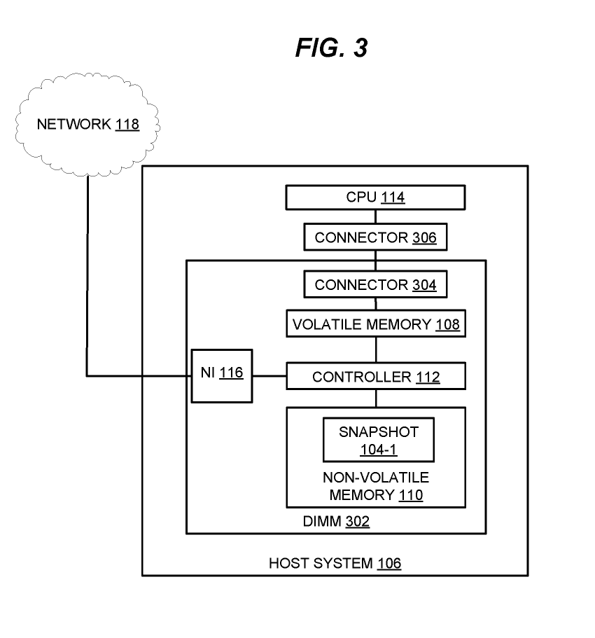

In some embodiments, volatile memory 108 may be included on a DIMM along with network interface 116, non-volatile memory 110, controller 112, and a connector that is electrically couplable to CPU 114. This is illustrated in FIG. 3. In this embodiment, a DIMM 302 includes a connector 304 that is electrically couplable to CPU 114 via a connector 306 of host system 106. For instance, DIMM 302 may be removably attached to host system 106 using connector 304.

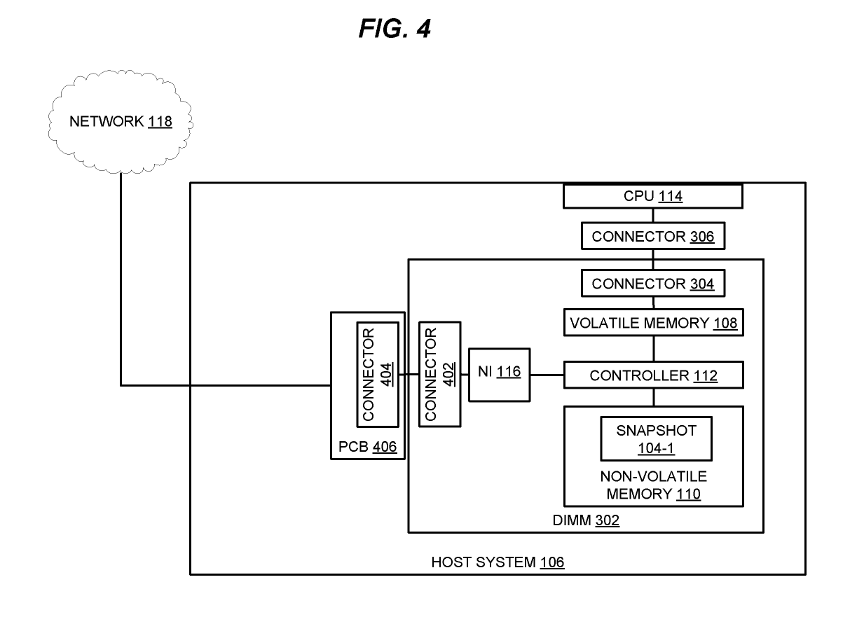

In some embodiments, DIMM 302 illustrated in FIG. 3 may include another connector that is removably couplable to a PCB. The PCB in this embodiment includes a communication connection to network 118. This is illustrated in FIG. 4. In this embodiment, DIMM 302 includes a connector 402 that is couplable to a connector 404 on PCB 408. PCB 406 includes a communication connection to network 118. For example, PCB may include a wired or wireless communication to network 118.

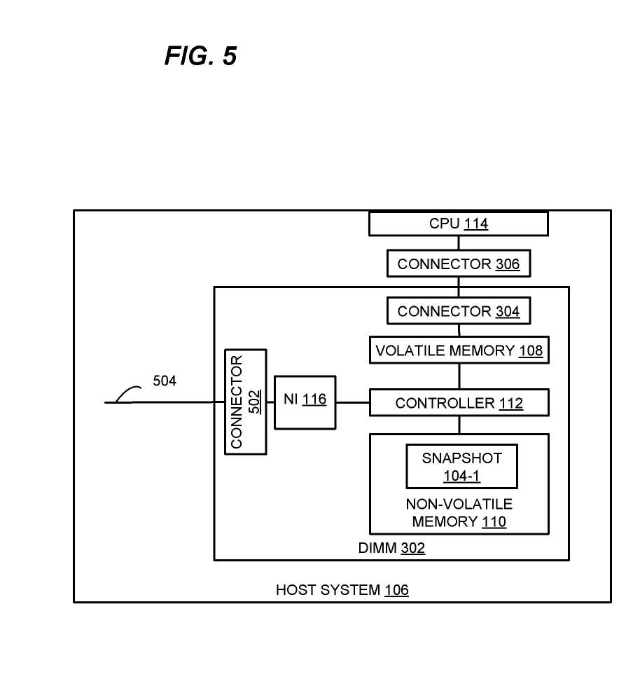

In some embodiments, DIMM 302 illustrated in FIG. 3 may include a connector and a cable that is removably couplable to the connector. This is illustrated in FIG. 5. In this embodiment, DIMM 302 includes a connector 502 and a cable 504. Cable 504 is removably couplable to connector 502.

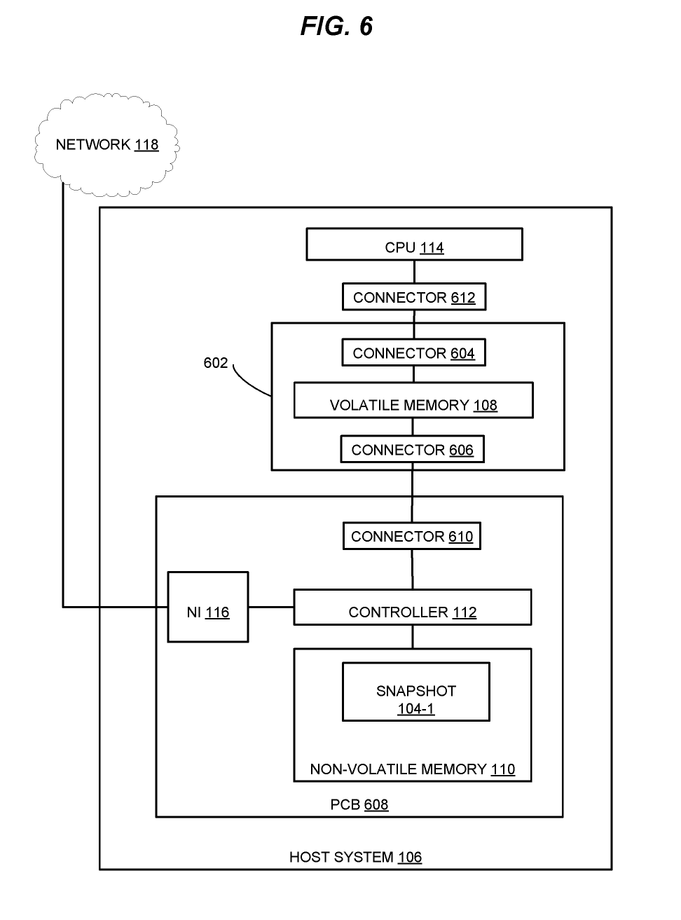

In some embodiments, volatile memory 108 may be included on a DIMM that includes electrical connectors that may be used to both couple volatile memory 108 to host system 106, and to controller 112. This is illustrated in FIG. 6. In this embodiment, a DIMM 602 includes volatile memory 108, a connector 604 that is able to electrically couple volatile memory 108 to CPU 114 (e.g., via connector 612 of host system 106), and a connector 606 that is able to electrically couple volatile memory 108 to a Printed Circuit Board (PCB) 608 utilizing a connector 610 on PCB 408. In this embodiment, PCB 608 includes connector 610, controller 112, non-volatile memory 110, and network interface 116. The use of this configuration allows PCB 608 to be removably couplable to DIMM 602 by mating connector 606 on DIMM 602 to connector 610 on PCB 608.

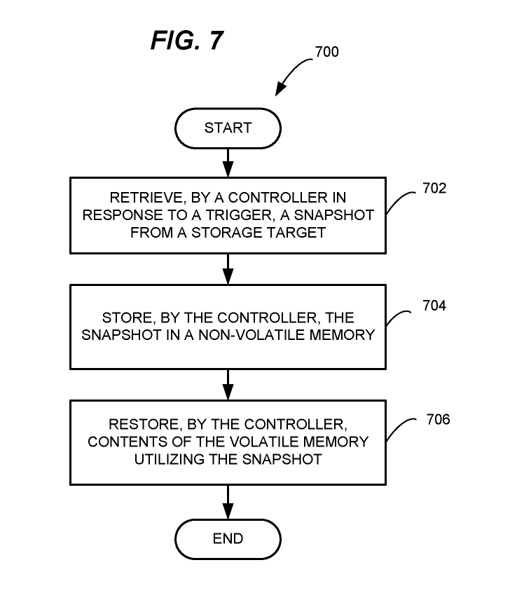

FIG. 7 is a flow chart of another method 700 operable by controller 112 of host system 106 for restoring snapshots in an exemplary embodiment. Controller 112 retrieves a snapshot (e.g., snapshot 104-1 utilizing network interface 116) in response to a trigger (see step 702). For instance, controller 112 may retrieve snapshot 104-1 from storage target 102 utilizing Remote Direct Memory Access (RDMA), which allows for direct memory access transfer from storage target 102 to host system 106. Controller 112 may retrieve a snapshot from one or more storage targets, not shown. Controller 112 may also retrieve a snapshot from an alternate host system (e.g., host system 106).

In cases where storage target 102 utilizes an object-based storage system, controller 112 may retrieve snapshot 104-1 from storage target 102 utilizing Object-based Storage Device (OSD) commands. In cases where storage target 102 utilizes a file storage system, storage target 102 stores snapshots 104 in a hierarchical structure.

The trigger to restore a snapshot may be a remote request received from network 118 by network interface 116 (e.g., by any third party entity), or the trigger to restore a snapshot may be generated via a direct electrical connection between host system 106 and controller 112. In some embodiments, the trigger to restore a snapshot is initiated by controller 112 in response to detecting a failure in the electrical power supplied to host system 106. For instance, controller 112 may utilize optional sensor 126 of host system 106 to monitor the electrical power supplied to host system 106, and generate the trigger to restore a snapshot in response to determining that electrical power supplied to host system 106 has been restored.

In response to retrieving snapshot 104-1 from storage target 102, controller 112 stores snapshot 104-1 in non-volatile memory 110 (see step 704). Controller 112 restores the contents of volatile memory 108 utilizing snapshot 104-1 stored at non-volatile memory 110 (see step 706). Controller 112 may restore the entire contents of volatile memory 108, or part of the contents of volatile memory 108. Controller 112 may also re-order the contents of volatile memory 108 as desired. In some embodiments, step 704 is skipped. In some cases, controller 112 may restore different contents to volatile memory 108. For instance, snapshot 104-2 may comprise the contents of volatile memory 109 of host system 107, which may be restored to volatile memory 108 of host system 106. Thus, it is possible to re-order, re-organize, or move the contents of volatile memory devices at host system 106 between different volatile memory devices and/or different host systems utilizing snapshots 104. The use of storage target 102 to store a large number of snapshots 104 allows for more flexibility in how snapshots 104 are generated, stored, and restored.

In some embodiments, snapshots 104 may be transferred from one host system to another host system. For example, controller 112 of host system 106 may generate a snapshot of volatile memory 108, and transfer the snapshot directly to non-volatile memory 111 of host system 107. In addition to or instead of, controller 112 of host system 106 may retrieve a snapshot from non-volatile memory 111 of host system 107, and restore snapshot (e.g., snapshot 104-2) to volatile memory 108.

The generation and retrieval of multiple snapshots 104 provides a number of advantages to host systems 106-107. For instance, many different snapshots 104 may be generated and stored at storage target 102 while host system 106 is executing a program, thereby allowing for a previous state in the program to be rapidly restored at host system 106. For example, if host system 106 is executing a simulation, then it is possible to generate snapshots capturing the state of the simulation at different points in time (e.g., every minute or so). It may be possible to then modify one or more variables in the simulation, and restore the state of the simulation to a previous time. This may allow for quickly evaluating different parameters in the simulation without re-starting the simulation from the beginning. The use of multiple snapshots 104 of host system 106 also allows for quick recovery of the execution of software executing on host system 106. For instance, a snapshot may be generated prior to a branch condition for software executing on host system 106, and one branch selected for processing. If, for instance, the alternate branch is desired to be processed, then the snapshot prior to the branch may be restored, and the alternate branch selected for processing. This also allows for quickly evaluating different branch conditions in the software executing on host system 106 at different points of time.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” may implicitly include, without limitation, digital signal processor (DSP) hardware, a network processor hardware, application specific integrated circuit (ASIC) hardware or other hardware circuitry, field programmable gate array (FPGA) hardware, or some other physical hardware component.

Also, the functionality described herein may be implemented as instructions executable by a processor or a computer to perform the functions. Some examples of instructions are software, program code, and firmware. The instructions are operational when executed by the processor to direct the processor to perform the functions. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope is not limited to those specific embodiments. Rather, the scope is defined by the following claims and any equivalents thereof.

1. An apparatus, comprising:
a Dual In-Line Memory Module (DIMM), comprising:
a connector;
a volatile memory configured to communicatively couple with a Central Processing Unit (CPU) of a host system via the connector, and to provide access to contents of the volatile memory to the CPU via the connector;
a network PHY interface that is configured to communicatively couple to a storage target over a network;
a non-volatile memory; and
a controller communicatively coupled to the volatile memory, the network PHY interface, and the non-volatile memory, and is configured, responsive to a trigger, to generate a snapshot comprising the contents of the volatile memory, and to store the snapshot in the non-volatile memory,
wherein the controller is configured to transmit the snapshot to the storage target utilizing the network PHY interface.

2. The apparatus of claim 1, wherein:
the controller is configured to transmit the snapshot to the storage target utilizing an object storage system.

3. The apparatus of claim 1, wherein:
the controller is configured to transmit the snapshot to the storage target utilizing Remote Direct Memory Access (RDMA).

4. The apparatus of claim 1, wherein:
the controller is configured to transmit the snapshot to the storage target utilizing a file storage system.

5. The apparatus of claim 1, wherein:
the trigger comprises a remote request that is received from the network by the network PHY interface.

6. The apparatus of claim 1, wherein:
the trigger is generated via a direct electrical connection between the host system that is utilizing the DIMM and the controller.

7. The apparatus of claim 1, wherein the DIMM further comprises:
a sensor that is configured to monitor an electrical power supplied to the host system that is utilizing the DIMM,
wherein the controller is configured to generate the trigger in response to determining that the sensor indicates a loss of the electrical power supplied to the host system.

8. The apparatus of claim 1, wherein:
the network PHY interface comprises an Ethernet PHY interface.

9. The apparatus of claim 1, wherein:
the connector comprises a first connector,
the DIMM includes a second connector that is communicatively coupled to the network PHY interface, and
the apparatus further includes:
a Printed Circuit Board (PCB) that is removably couplable to the second connector and includes a communication connection to the network.

10. The apparatus of claim 1, wherein:
the connector comprises a first connector, and
the DIMM includes a second connector and a cable that is removably couplable to the second connector.

11. The apparatus of claim 1, wherein:
the connector comprises a first connector,
the DIMM includes a second connector, and
the apparatus further comprises:
a Printed Circuit Board (PCB) that is removably couplable to the second connector, wherein the PCB includes the network PHY interface, the non-volatile memory, and the controller.

12. A method operable by a Dual In-Line Memory Module (DIMM) that includes a connector, a volatile memory configured to communicatively couple with a Central Processing Unit (CPU) of a host system via the connector, the volatile memory configured to provide access to contents of the volatile memory to the CPU via the connector, a network PHY interface that is configured to communicatively couple to a storage target over a network, a non-volatile memory, and a controller communicatively coupled to the volatile memory, the network PHY interface, and the non-volatile memory, the method comprising:
generating by the controller in response to a trigger, a snapshot comprising the contents of the volatile memory;
storing, by the controller, the snapshot in the non-volatile memory; and
transmitting, by the controller, the snapshot to the storage target utilizing the network PHY interface.

13. The method of claim 12, wherein transmitting the snapshot further comprises:
transmitting the snapshot to the storage target utilizing an object storage system.

14. The method of claim 12, wherein transmitting the snapshot further comprises:
transmitting the snapshot to the storage target utilizing Remote Direct Memory Access (RDMA).

15. The method of claim 12, wherein transmitting the snapshot further comprises:
transmitting he snapshot to the storage target utilizing a file storage system.

16. The method of claim 12, wherein:
the trigger comprises a remote request that is received from the network by the network PHY interface.

17. The method of claim 12, wherein:
the trigger is generated via a direct electrical connection between the host system that is utilizing the DIMM and the controller.

18. The method of claim 12, further comprising:
monitoring, by a sensor of the DIMM, an electrical power supplied to the host system that is utilizing the DIMM;
determining, by the controller, that the sensor indicates a loss of the electrical power; and
generating, by the controller, the trigger in response to the determination.

19. An apparatus, comprising:
a Dual In-Line Memory Module (DIMM), comprising:
a connector;
a volatile memory configured to communicatively couple with a Central Processing Unit (CPU) of a host system via the connector, and to provide access to contents of the volatile memory to the CPU via the connector;
a network PHY interface that is configured to communicatively couple to a storage target over a network;
a non-volatile memory; and
a controller communicatively coupled to the volatile memory, the network PHY interface, and the non-volatile memory, and is configured, responsive to a trigger, to retrieve a snapshot from the storage target utilizing the network PHY interface, and to store the snapshot in the non-volatile memory,
wherein the controller is further configured to restore the contents of the volatile memory utilizing the snapshot.

20. The apparatus of claim 19, wherein:
the controller is configured to retrieve the snapshot from the storage target utilizing an object storage system.

21. The apparatus of claim 19, wherein:
the controller is configured to retrieve the snapshot from the storage target utilizing Remote Direct Memory Access (RDMA).

22. The apparatus of claim 19, wherein:
the controller is configured to retrieve the snapshot from the storage target utilizing a file storage system.

23. The apparatus of claim 19, wherein:
the trigger comprises a remote request that is received from the network by the network PHY interface.

24. The apparatus of claim 19, wherein:′
the trigger is generated via a direct electrical connection between the host system that is utilizing the DIMM and the controller.

25. The apparatus of claim 19, wherein the DIMM further comprises:
a sensor that is configured to monitor an electrical power supplied to the host system that is utilizing the DIMM,
wherein the controller is configured to generate the trigger in response to determining that the sensor indicates a return of the electrical power supplied to the host system.

26. The apparatus of claim 19, wherein:
the network PHY interface comprises an Ethernet PHY interface.

27. The apparatus of claim 19, wherein:
the connector comprises a first connector,
the DIMM includes a second connector that is communicatively coupled to the network PHY interface, and
the apparatus further comprises:
a Printed Circuit Board (PCB) that is removably couplable to the second connector and includes a communication connection to the network.

28. The apparatus of claim 19, wherein:
the connector comprises a first connector, and
the DIMM includes a second connector and a cable that is removably couplable to the second connector.

29. The apparatus of claim 19, wherein:
the connector comprises a first connector,
the DIMM includes a second connector, and
the apparatus further comprises:
a Printed Circuit Board (PCB) that is removably couplable to the second connector, wherein the PCB includes the network PHY interface, the non-volatile memory, and the controller.

30. A method operable by a Dual In-Line Memory Module (DIMM) that includes a connector, a volatile memory configured to communicatively couple with a Central Processing Unit (CPU) of a host system via the connector, the volatile memory configured to provide access to contents of the volatile memory to the CPU via the connector, a network PHY interface that is configured to communicatively couple to a storage target over a network, a non-volatile memory, and a controller communicatively coupled to the volatile memory, the network PHY interface, and the non-volatile memory, the method comprising:
retrieving by the controller in response to a trigger, a snapshot from the storage target utilizing the network PHY interface;
storing, by the controller, the snapshot in the non-volatile memory; and
restoring, by the controller, the contents of the volatile memory utilizing the snapshot.

31. The method of claim 30, wherein retrieving the snapshot further comprises:
retrieving the snapshot from the storage target utilizing an object storage system.

32. The method of claim 30, wherein retrieving the snapshot further comprises:
retrieving the snapshot from the storage target utilizing Remote Direct Memory Access (RDMA).

33. The method of claim 30, wherein retrieving the snapshot further comprises:
retrieving the snapshot from the storage target utilizing a file storage system.

34. The method of claim 30, wherein:
the trigger comprises a remote request that is received from the network by the network PHY interface.

35. The method of claim 30, wherein:
the trigger is generated via a direct electrical connection between the host system that is utilizing the DIMM and the controller.

36. The method of claim 30, further comprising:
monitoring, by a sensor of the DIMM, an electrical power supplied to the host system that is utilizing the DIMM;
determining, by the controller, that the sensor indicates a return of the electrical power supplied to the host system; and
generating, by the controller, the trigger in response to the determination.
